(19) United States
(12) Patent Application Publication
(10) Pub. No.: US 2026/0171719 A1
(43) Pub. Date: Jun. 18, 2026

(54) CONNECTION DEVICE

(71) Applicant: Cardo Systems, Ltd., Ra’anana (IL)

(72) Inventors: Boaz LEVI, Binyamina (IL); Eran LAZAROVICH, Misgav Dov (IL)

(73) Assignee: Cardo Systems, Ltd., Ra’anana (IL)

(21) Appl. No.: 19/127,359

(22) PCT Filed: Nov. 6, 2023
(86) PCT No.: PCT/IB2023/061177

§ 371 Date: May 5, 2025

Related U.S. Application Data
(60) Provisional application No. 63/423,259, filed on Nov. 7, 2022.

(51) Int. Cl. H01R 13/639; A42B 3/04; H04W 4/80

(52) U.S. Cl. CPC H01R 13/639; A42B 3/0406; H04W 4/80

(57) ABSTRACT

A connection device is described. The connection device can include first connection element and a second connection element, which can be brought into engagement with one another in a connection direction. The connection device can include a securing element allocated to the first connection element, which securing element is linearly displaceable relative to the first connection element in a securing direction between a release position and a securing position, the securing direction being different from the connection direction, and a projection arranged on the second connection element. The securing element has at least one engagement portion which, in the securing position, positively engages behind an associated counter-engagement portion of the projection with respect to a relative displacement of the first and second connection elements counter to the connection direction.

The invention relates to a connection device comprising a first connection element and a second connection element, which can be brought into engagement with one another in a connection direction, and a securing element allocated to the first connection element and displaceable relative to the first connection element between a release position and a securing position.

A connection device of the afore-mentioned type is distributed by BIKECOMM Open Road Solutions, Inc., Taiwan. In this connection device, the securing element is pivotably attached to the first connection element using a short projection and an allocated recess at both sides of the first connection element and the securing element, respectively. Such pivoting joints, however, are known to be of little mechanical robustness. For example, the securing element may easily come off the first connection element. Thus, there is the risk that the securing element is lost and may no longer fulfil its purpose of securing the connection of the first and second connection elements.

In view of the above, it is the object of the present invention to provide an improved connection device.

According to the present invention, this object is solved by a connection device comprising a first connection element and a second connection element, which can be brought into engagement with one another in a connection direction, a securing element allocated to the first connection element, which securing element is linearly displaceable relative to the first connection element in a securing direction between a release position and a securing position, the securing direction being different from the connection direction, and a projection arranged on the second connection element, wherein the securing element has at least one engagement portion which, in the securing position, positively engages behind an associated counter-engagement portion of the projection with respect to a relative displacement of the first and second connection elements counter to the connection direction. In particular, the linear relative displacement of two parts may be achieved in mechanically very robust constructional ways. Furthermore, the positive engagement of the securing element and the second connection element ensures that the connection may not be released inadvertently, in particular not by vibrations, e.g. during outdoor activities, or if at least one of the first connection element, the securing element and an element attached to the first connection element, e.g. a cable, is tangled in use, e.g. in a tree, in the user's gloves, the user's clothing or the like. Moreover, a reliable connection may be guaranteed even after a large number of repeated uses, in comparison to a connection based on mere friction that could wear after a certain number of uses.

According to a further advantageous embodiment, the positive engagement of the securing element and the second connection element may be supplemented by a frictional engagement of the securing element and the second connection element established during the linear relative displacement of these two parts at least close to the securing position of the securing element. For example, the distance of two engagement portions of the securing element facing towards each other may decrease with increasing distance from said end of the securing element first coming into contact with the projection of the second connection element when transferring the securing element from its releasing position to its securing position.

For example, the connection device may be a plug-in connection device, said first connection element being a first plug-in connection element, for example a plug, and said second connection element being a second connection plug-in element, for example a socket. In this case, the positive engagement of the securing element and the second plug-in connection element may only be established if the first and second plug-in connection elements are completely connected, thus ensuring correct connection of the two plug-in connection elements.

According to a further embodiment, the securing element may be undetachably held on the first connection element, thus ensuring that the securing element may not come off and get lost. For example, the securing element may include an opening completely surrounded by the material forming the securing element, the first connection element or a part connected thereto extending through this opening in both, the release position and the securing position. In the case of a plug-in connection, said part connected to the first connection element may, for example, be a cord, in particular a cord for transmitting at least one of electrical power and data. In particular, the cord may be used only for charging purposes, while data are transmitted in a wireless way, e.g. using Bluetooth® technology.

According to a further embodiment, a stop may be provided on the first connection element, and a counter-stop may be provided on at least one of the securing element and the second connection element, the stop and the counter-stop being adapted to interact in order to prevent movement of the securing element beyond the securing position. Thus, it may be ensured that the securing element may fulfil its securing purpose.

With the same objective, the securing element may be provided with a latch adapted to cooperate with at least one of the first connection element and the second connection element, in order to releasably retain the securing element in the securing position.

As an alternative or in addition to the latch, the securing element and the first connection element, in the securing position, may be held together by means of an interference fit. For example, the first connection element may comprise a cylindrical portion adapted and intended to interference fit into a cylindrical recess of the securing element. Said cylindrical recess may be formed, for example, by the afore-mentioned opening of the securing element.

According to an alternative embodiment, such an interference fit may be dispensed with to avoid that the securing element is held in its securing position although said first and second connection elements are not connected to each other. In this case, it may not be obvious to a first-time user that s/he should first retract the securing element before connecting the first and second connection elements. Thus, there is the risk of damaging at least the securing element when trying to establish the connection of the first and second connection elements.

In order to increase the mechanical robustness of the connection of the first and second connection elements, the securing direction may be substantially orthogonal to the connection direction.

In order to facilitate the manufacturing of the securing element and thus reduce the manufacturing costs thereof, the securing element may be made from plastic material, e.g. by injection molding.

According to a further embodiment, the connection device may be a USB connection device, for example, a USB C connection device.

According to a further embodiment, the second connection element may part of a functional unit, for example a communication unit, in particular a Bluetooth® communication unit.

Furthermore, said functional unit may either be directly or indirectly attached to a head protective gear. For example, said functional unit may be attached to a receiving unit which either is integral part of the head protection gear (direct attachment) or formed as a separate unit operatively fixable to said head protection gear (indirect attachment).

It should be noted that the head protective gear generally may be of any design. In particular, the head protective gear may include a hard shell or a soft shell. As head protective gears including a hard shell, motorcycle helmets, bicycle helmets, skiing and snowboarding helmets or helmets worn when performing other types of sports activities, e.g. American Football and the like, professional protective helmets, e.g. helmets worn by fire fighters, law enforcement forces, soldiers, pilots of aircrafts and/or helicopters and the like, are known. These helmets may be of different design. In particular, the helmet may be a full helmet, a cross helmet, a flip-up helmet, a jet helmet, a brain cap and the like. Head protective gears including a soft shell, for example, are used in martial arts, e.g. boxing, kickboxing and the like.

In the following, the invention will be described in more detail referring to a specific embodiment shown in the attached drawings, in which

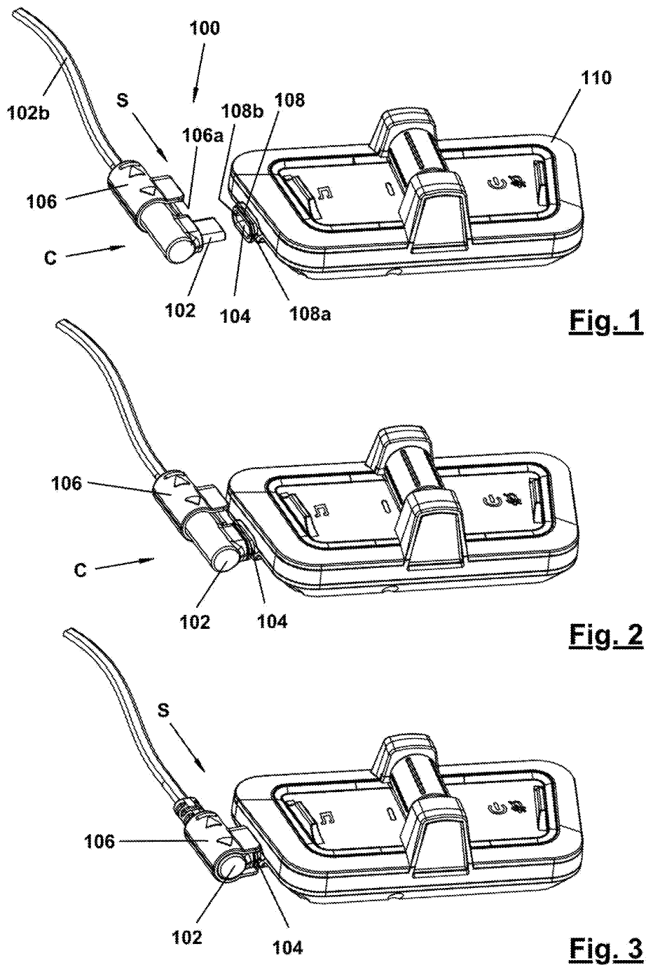

FIGS. 1 to 3 are perspective views of an embodiment of the connection device according to the present invention in different phases of the connecting and securing process;

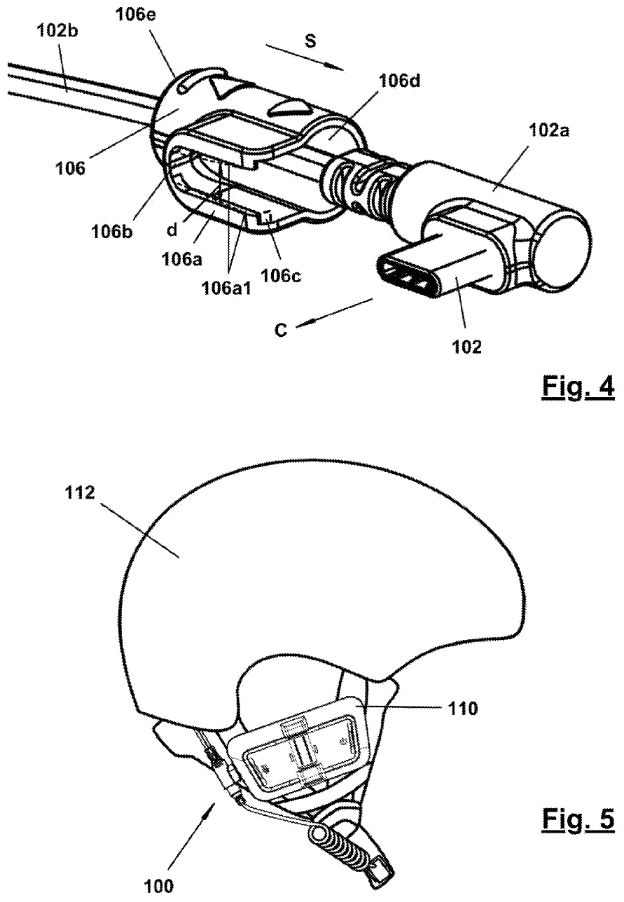

FIG. 4 is a perspective view of the embodiment of FIGS. 1 to 3 seen from a different direction; and

FIG. 5 is a side view of a head protective gear having a communication device including the connection device according to FIGS. 1 to 4 attached thereto.

In FIG. 1, a connection device according to the present invention is generally denoted by 100. The connection device 100 includes a first connection element 102 and a second connection element 104, which can be brought into engagement with one another in a connection direction indicated by an unidirectional arrow C. In the embodiment shown in the drawings, the connection device 100 is a USB C plug-in connection device including a USB C plug as the first connection element 102 and a USB C socket as the second connection element 104.

According to the invention, a securing element 106 is allocated to the first connection element 102. The securing element 106 is linearly displaceable relative to the first connection element 102 in a securing direction indicated by unidirectional arrow S between a release position shown in FIG. 1 and a securing position shown in FIG. 3. In the embodiment shown, the securing direction S extends substantially orthogonal to the connection direction C.

The securing element 106 is adapted and intended to cooperate with a projection 108 arranged on the second connection element 104. In particular, the securing element 106 has at least one engagement portion 106a (see also FIG. 4) which, in the securing position, positively engages behind an associated counter-engagement portion 108a of the projection 108 with respect to a relative displacement of the first and second connection elements 102, 104 counter to the connection direction C.

In order to establish the connection, in a first step, the first connection element 102, i.e. the plug, and the second connection element 104, i.e. the socket, are brought in close vicinity to each other (see FIG. 1). In a second step, the plug is inserted into the socket by approaching it in the connection direction C (see FIG. 2), in order to establish the connection. During this second step, the securing element 106 still is in its releasing position. Finally, in a third step, the securing element 106 is transferred along the first connection element 102, i.e. in the securing direction S, into the securing position (see FIG. 3), in order to secure the connection between plug and socket.

In order to prevent movement of the securing element 106 beyond the securing position, and thus provide a well-defined securing position, a stop 106b (see FIG. 4) is provided on the securing element 106 and a counter-stop 108b is provided on the second connection element 104, in particular the projection 108 thereof.

In order to releasably retain the securing element 106 in the securing position, the securing element 106 may be provided with a latch 106c adapted to cooperate with the second connection element 104, in particular the projection 108 thereof.

To the same end, the securing element 106 and the first connection element 102, in the securing position, may be held together by means of an interference fit. For example, the first connection element 102 may comprise a cylindrical portion 102a (see FIG. 4) adapted and intended to interference fit into a cylindrical recess 106d of the securing element 106.

In order not to jeopardize the operability of the securing element 106, the securing element 106 may be undetachably held on the first connection element 102. For example, the securing element 106 may include an opening 106e (see FIG. 4) completely, i.e. over the full 360°, surrounded by the material forming the securing element 106, and the first connection element 102 or a part 102b connected thereto, i.e. a cord, may extend through this opening 106e in both, the release position and the securing position.

In this context, it should be noted that, according to a further embodiment, it may be only the opening 106e which enters into interference fit engagement with the cylindrical portion 102a, while the cylindrical recess 106d of the securing element 106 is positioned at a certain distance from the cylindrical portion 102a.

According to a further embodiment, exaggeratingly indicated in dashed lines in FIG. 4, the positive engagement of the securing element 106 and the second connection element 104 may be supplemented by a frictional engagement of the securing element 106 and the second connection element 104. To this end, the upper and lower edges 106a1 of the upper and lower engagement portions 106a may extend not strictly parallel to each other, but in a narrowing way. In particular, the distance d of the edges 106a1 may decrease from the open end, i.e. the end facing towards the first connection element 102, to the closed end forming the stop 106b.

As may be seen from all Figures, the second connection element 102 may be part of a functional unit 110, in particular a communication unit, e.g. a Bluetooth® communication unit. Such communication units are as such known in the art. Furthermore, it is known and shown in FIG. 5 that such communication units may be attached to a head-protective gear 112, for example a helmet used for outdoor sports activities.

Item 1. A connection device (100) comprising:
a first connection element (102) and a second connection element (104), which can be brought into engagement with one another in a connection direction (C),
a securing element (106) allocated to the first connection element (102), which securing element (106) is linearly displaceable relative to the first connection element (102) in a securing direction (S) between a release position and a securing position, the securing direction (S) being different from the connection direction (C), and
a projection (108) arranged on the second connection element (104),
wherein the securing element (106) has at least one engagement portion (106a) which, in the securing position, positively engages behind an associated counter-engagement portion (108a) of the projection (108) with respect to a relative displacement of the first and second connection elements (102, 104) counter to the connection direction (C).

Item 2. The connection device of item 1,
wherein the connection device (100) is a plug-in connection device, said first connection element (102) being a first plug-in connection element and said second connection element (104) being a second connection plug-in element.

Item 3. The connection device of item 1 or item 2, wherein the securing element (106) is undetachably held on the first connection element (102).

Item 4. The connection device of item 3,
wherein the securing element (106) includes an opening (106e) completely surrounded by the material forming the securing element (106), the first connection element (102) or a part (102b) connected thereto extending through this opening (106e) in both, the release position and the securing position.

Item 5. The connection device of any of items 1 to 4,
wherein a stop (106b) is provided on the securing element (106) and a counter-stop (108b) is provided on at least one of the first connection element and the second connection element (102), the stop (106b) and the counter-stop (108b) being adapted to interact in order to prevent movement of the securing element (106) beyond the securing position.

Item 6. the Connection Device of Any of Items 1 to 5,
wherein the securing element (106) is provided with a latch (106c) adapted to cooperate with at least one of the first connection element (102) and the second connection element (104) in order to releasably retain the securing element (106) in the securing position.

Item 7. The connection device of any of items 1 to 6,
wherein the securing element (106) and the first connection element (102), in the securing position, are held together by means of an interference fit.

Item 8. The connection device of any of items 1 to 7,
wherein the securing direction (S) is substantially orthogonal to the connection direction (C).

Item 9. The connection device of any of items 1 to 8,
wherein the securing element (106) is made from plastic material.

Item 10. The connection device of any of items 2 to 9,
wherein the connection device (109) is a USB connection device, e.g. a USB C connection device.

Item 11. The connection device of any of items 2 to 10,
wherein the first connection element (102) is a plug.

Item 12. The connection device of any of items 2 to 11,
wherein the second connection element (104) is a socket.

Item 13. The connection device of any of items 1 to 12,
wherein the second connection element (104) is part of a functional unit (110).

Item 14. The connection device of item 13,
wherein the functional unit (110) is directly or indirectly attached to a head protective gear (112).

Item 15. The connection device of item 13 or item 14,
wherein the functional unit (110) is a communication unit, e.g. a Bluetooth® communication unit.

1. A connection device comprising:
a first connection element and a second connection element, wherein the first connection element and the second connection element can be brought into engagement with one another in a connection direction;
a securing element allocated to the first connection element, wherein the securing element is linearly displaceable relative to the first connection element in a securing direction between a release position and a securing position, the securing direction being different from the connection direction; and
a projection arranged on the second connection element, wherein the securing element has at least one engagement portion which, in the securing position, positively engages behind an associated counter-engagement portion of the projection with respect to a relative displacement of the first connection element and the second connection element counter to the connection direction.

2. The connection device of claim 1, wherein the connection device is a plug-in connection device, and wherein the first connection element includes a first plug-in connection element and the second connection element includes a second connection plug-in element.

3. The connection device of claim 1, wherein the securing element is undetachably held on the first connection element.

4. The connection device of claim 3, wherein the securing element includes an opening completely surrounded by the securing element, the first connection element or a part connected thereto extending through the opening in both the release position and the securing position.

5. The connection device of claim 1, wherein a stop is provided on the securing element and a counter-stop is provided on at least one of the first connection element and the second connection element, the stop and the counter-stop being adapted to interact in order to prevent movement of the securing element beyond the securing position.

6. The connection device of claim 1, wherein the securing element is provided with a latch adapted to cooperate with at least one of the first connection element and the second connection element in order to releasably retain the securing element in the securing position.

7. The connection device of claim 1, wherein the securing element and the first connection element, in the securing position, are held together by means of an interference fit.

8. The connection device of claim 1, wherein the securing direction is substantially orthogonal to the connection direction.

9. The connection device of claim 1, wherein the securing element is made from a plastic material.

10. The connection device of claim 2, wherein the plug-in connection device is a universal serial bus (“USB”) connection device.

11. The connection device of claim 10, wherein the plug-in connection device is a USB C connection device.

12. The connection device of claim 2, wherein the first connection element is a plug.

13. The connection device of claim 2, wherein the second connection element is a socket.

14. The connection device of claim 1, wherein the second connection element is part of a functional unit.

15. The connection device of claim 14, wherein the functional unit is directly or indirectly attached to a head protective gear.

16. The connection device of claim 14, wherein the functional unit is a communication unit.

17. The connection device of claim 16, wherein the communication unit is a Bluetooth® communication unit.
